(19) United States
(12) Patent Application Publication
(10) Pub. No.: US 2020/0019864 A1
(43) Pub. Date: Jan. 16, 2020

(54) SYSTEMS AND METHODS FOR ARTIFICIAL-INTELLIGENCE-BASED AUTOMATED OBJECT IDENTIFICATION AND MANIPULATION

(71) Applicant: DEEPBRAIN CHAIN, INC., Santa Clara, CA (US)

(72) Inventors: Haisong Gu, Cupertino, CA (US); Dongyan Wang, Santa Clara, CA (US); Kuangyuan Sun, Chicago, IL (US); Mingze Xu, Plano, TX (US)

(21) Appl. No.: 16/049,720

(22) Filed: Jul. 30, 2018

Related U.S. Application Data
(60) Provisional application No. 62/696,767, filed on Jul. 11, 2018.

(51) Int. Cl. G06N 5/02; G06Q 20/36

(52) U.S. Cl. CPC G06N 5/02; G06Q 20/3678

(57) ABSTRACT

The disclosed computer-implemented system and method for artificial-intelligence-based automated object identification and manipulation can include receiving a subsystem request from a third-party entity, the request being related to a subsystem for an object identification and manipulation system. The system and method also includes creating a developer request for a model suitable for the subsystem, the developer request including at least one approval condition. The system and method further includes evaluating a developer proposal received in response to the developer request, the developer proposal including a trained model, the evaluating including determining an accuracy level of the trained model, and the evaluating includes designating the trained model as an approved model if the developer proposal is approved. Also, the system and method includes providing the approved model to the third-party entity in response to the subsystem request.

### CROSS-REFERENCE TO RELATED APPLICATION

This application claims priority to U.S. patent application Ser. No. 62/696,767, filed Jul. 11, 2018 which is incorporated herein by reference in its entirety.

### FIELD OF THE INVENTION

The present disclosure relates to systems and methods involving interpretation of sensor data for autonomous object grasping and manipulation operations.

### BACKGROUND

There are many different industries that have requirements to identify or otherwise classify objects, and to lift, move, or otherwise manipulate objects. For example, the shipping industry involves identifying goods to properly pack and route the goods to prevent loss and damage. Also, in the retail industry, goods are identified for proper pricing, stocking, shipping, and shelf-life, and are moved from factory to warehouse to retailer, where they are sorted and stocked. These tasks can be time and labor intensive, which translates to additional costs in a supply chain or in a shipping operation.

The instant disclosure, therefore, identifies and addresses a need for systems and methods for artificial-intelligence-based automated object identification and manipulation.

### SUMMARY

As will be described in greater detail below, the instant disclosure describes various systems and methods for artificial-intelligence-based automated object identification and manipulation.

In some embodiments, for example, a method for artificial-intelligence-based automated object identification and manipulation can include receiving a subsystem request related to a subsystem for an object identification and manipulation system. The method can also include creating a developer request for a model suitable for the subsystem, the developer request including at least one approval condition. The method can further comprise evaluating a developer proposal received in response to the developer request, wherein the developer proposal includes a trained model, wherein the evaluating includes determining an accuracy level of the trained model, and wherein the evaluating includes designating the trained model as an approved model if the developer proposal is approved. The method also includes providing the approved model to the third-party entity in response to the subsystem request.

The computer-implemented method can further comprise collecting working environment information related to the subsystem request from the third-party entity.

The computer-implemented method can further comprise analyzing the working environment information to determine subsystem requirements.

The computer-implemented method can further comprise receiving customer data related to an operation of the subsystem, the customer data including at least one of automated object identification and automated object manipulation.

The computer-implemented method can further comprise customer data representative of at least one physical feature for each of a plurality of different objects.

The computer-implemented method can further comprise customer data that includes data representative of at least one grasping parameter for each of a plurality of different objects.

The computer-implemented method can further comprise a condition related to price, wherein the price increases after a predetermined period of time if no satisfactory model has yet been received.

The computer-implemented method can include a developer request that includes a smart contract that is stored in a blockchain structure and is automatically signed upon approval of a developer proposal.

According to some aspects, a system for artificial-intelligence-based automated object identification and manipulation can comprise a receiving module that receives, from a third-party entity, a subsystem request related to a subsystem for an object identification and manipulation system; a creating module that creates a developer request for a model suitable for the subsystem, the developer request including at least one approval condition; an evaluating module, stored in memory, that evaluates a developer proposal received in response to the developer request, wherein the developer proposal includes a trained model, wherein the evaluating includes determining an accuracy level of the trained model, and wherein the evaluating includes designating the trained model as an approved model if the developer proposal is approved; and a providing module, stored in memory, that provides the approved model to the third-party entity in response to the subsystem request. The system also includes at least one physical processor that executes the receiving module, the creating module, the evaluating module, and the providing module.

The system can further comprise a collecting module, stored in memory, that collects working environment information related to the subsystem request from the third-party entity.

The system can further comprise an analyzing module, stored in memory, that analyzes the working environment information to determine subsystem requirements.

The system can further comprise a receiving module, stored in memory, that receives from the third-party entity, includes customer data related to an operation of the subsystem, the customer data including at least one of automated object identification and automated object manipulation.

The system can further comprise customer data that includes data representative of at least one physical feature for each of a plurality of different objects.

The system can further comprise customer data that includes data representative of at least one grasping parameter for each of a plurality of different objects.

The system can further comprise a condition related to price, wherein the price increases after a predetermined period of time if no satisfactory model has yet been received.

The system can further comprise a developer request that includes a smart contract that is stored in a blockchain structure and is automatically signed upon approval of a developer proposal.

According to yet another aspect, a computer-implemented method for artificial-intelligence-based automated object identification and manipulation comprises generating sensed information data about an object collected using one or more sensors; identifying an object using the sensed information data, including recognizing the object as being one of a plurality of different candidate items; retrieving grasp data representative of grasp parameters for the object; and generating grasp command data for controlling a grasping tool to grasp and manipulate the object, the grasp command data being generated based at least in part on the grasp data; collecting devices, grasp quality data representative of grasping-tool interactions with the object while the grasping tool grasps and manipulates the object; and providing the grasp quality data to a training network for training a model related to the grasping tool.

The computer-implemented method can further comprise the sensed information data includes at least one of image data, location data, and orientation data.

The computer-implemented method can further comprise the grasp quality data includes sensor data collected by at least one sensor while monitoring grasping-tool as the grasping tool grasps and manipulates the object. The computer-implemented method can further comprise the grasp parameters include information related to grasping surfaces of the object. The computer-implemented method can further comprise the grasp parameters include information related to grasping force limits for the object.

The computer-implemented method can receive compensation in exchange for the grasp quality data, wherein compensation includes at least one of a flat currency and a virtual currency.

Features from any of the above-mentioned embodiments may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

FIG. 1 is a block diagram of an example system for artificial-intelligence-based automated surface inspection.

FIG. 2 is a block diagram of an example system including a computing device in communication with a server.

FIG. 3 is a flow diagram of an example computer-implemented method for artificial intelligence based automated surface inspection.

FIGS. 4, 5A-5D, and 6 show schematic block diagrams of embodiments of AI-based automated object identification and manipulation systems according to the present disclosure.

FIG. 7 shows a block diagram of a grasp quality convolutional neural network.

FIGS. 8-9 show schematic block diagrams of embodiments of AI-based automated object identification and manipulation systems according to the present disclosure.

FIG. 10 is a flow diagram of an example computer-implemented method for artificial intelligence based automated surface inspection.

### DETAILED DESCRIPTION

This disclosure relates to artificial-intelligence- (AI-) based automated object identification and manipulation. Machine learning is a subset of AI in the field of computer science. Machine Learning teaches computers to learn from experience. This involves the use of algorithms that can “learn” directly from data without relying on a predetermined equation. Machine Learning algorithms seek natural patterns in data and discover patterns that lead to better predictions and decisions. These algorithms are used in image processing and computer vision for such tasks as edge detection, object detection, image recognition, and image segmentation. The algorithms adaptively improve their performance as the number of available data samples increases.

Embodiments of the systems and methods disclosed herein use machine learning techniques to become proficient at predicting an output for an unknown input. The proficiency is developed through training a data model, which can be done according to supervised learning or unsupervised learning techniques. Supervised learning generally involves training a model using a training data set. A training data set is specially prepared for training, because it includes both inputs and corresponding outputs. When a model is in training mode and fed training data, the goal is to process the data from the input repeatedly to approach the optimal outputs as closely as practical. Each time the training data is fed through the model, there is the potential for the model to self-adjust, e.g., by changing weights or tuning parameters, as the model trains to reduce a cost function, which can be thought of as a distance from optimization.

The unsupervised learning techniques differ from supervised techniques by not utilizing training data. Instead, the model is left to draw inferences from the datasets without any know target optimization points. An example of unsupervised learning is clustering. Applications for clustering can also include object recognition in images. Clustering seeks out hidden patters or groupings in the data.

The supervised learning technique can be used for classification or for regression training. Classification techniques are used with discrete inputs to predict a class membership for the input, where the image is classified with one classification from among two or more possible classes. Regression, on the other hand, is used for scenarios involving somewhat continuous inputs, such as changes in flow rate or temperature.

Clustering, classification, and regression represent families of algorithms, leaving dozens of available options for processing data. Algorithm selection can depend on several factors, such as the size and type of data being collected and analyzed, the insights the data is meant to reveal, and how those insights will be used. Advantageously, according to some aspects of the present disclosure, systems and methods disclosed herein can make trained models more accessible than in the past, offering system designers and data scientists with additional resources for choosing the right algorithm for a given scenario.

Once the algorithm has been chosen, there remains the task of building the data model, including the training process. Typically, training such models is a burdensome task involving getting access to large amounts of data and processing power, which can mean considerable, or possibly prohibitive, time and expense.

Advantageously, systems and methods disclosed herein can reduce these burdens. For example, embodiments disclosed herein provide for access to a decentralized network having nodes that can collectively provide scalable amounts of processing power for training models. The decentralized network can also maintain a decentralized blockchain structure supporting blockchain-based encryption that serves as a secure and verifiable data-transfer channel. This data-transfer channel enables the ability to safely trade data, subsystems, and computing resources

Embodiments disclosed herein can also improve the model-training process by reducing the time and expense normally involved. For example, pre-trained models can be used that require less time, data, and expense to optimize compared to starting with a new, untrained model. Also, the training can be accomplished by distributing the processing among a network of nodes, e.g., computing devices, that can collectively complete the model training or otherwise improve model performance.

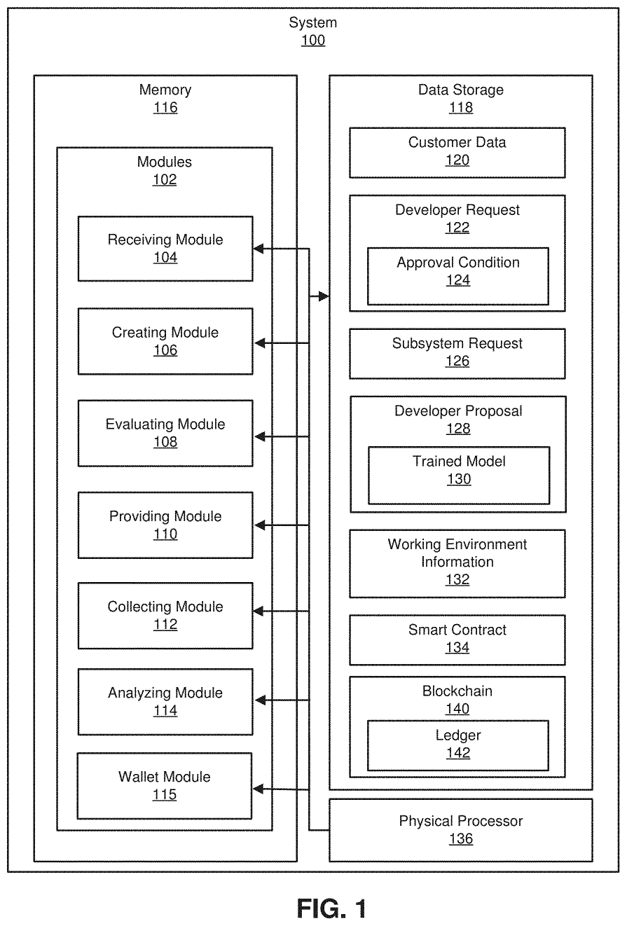

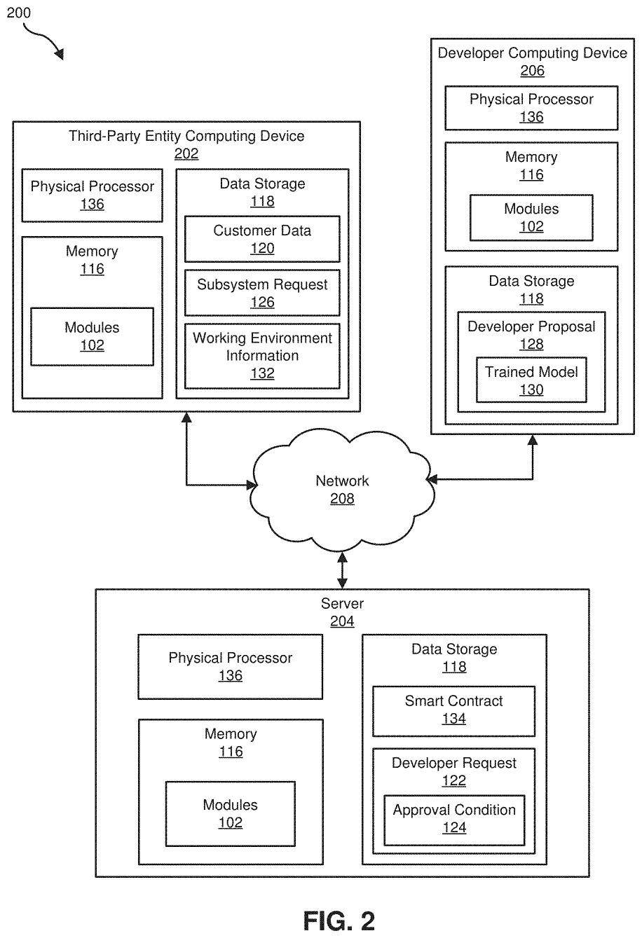

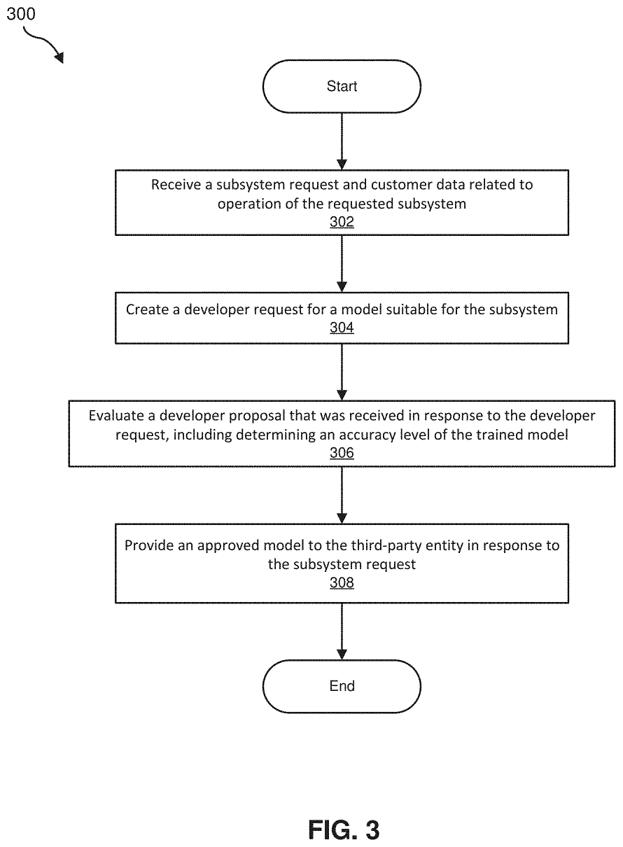

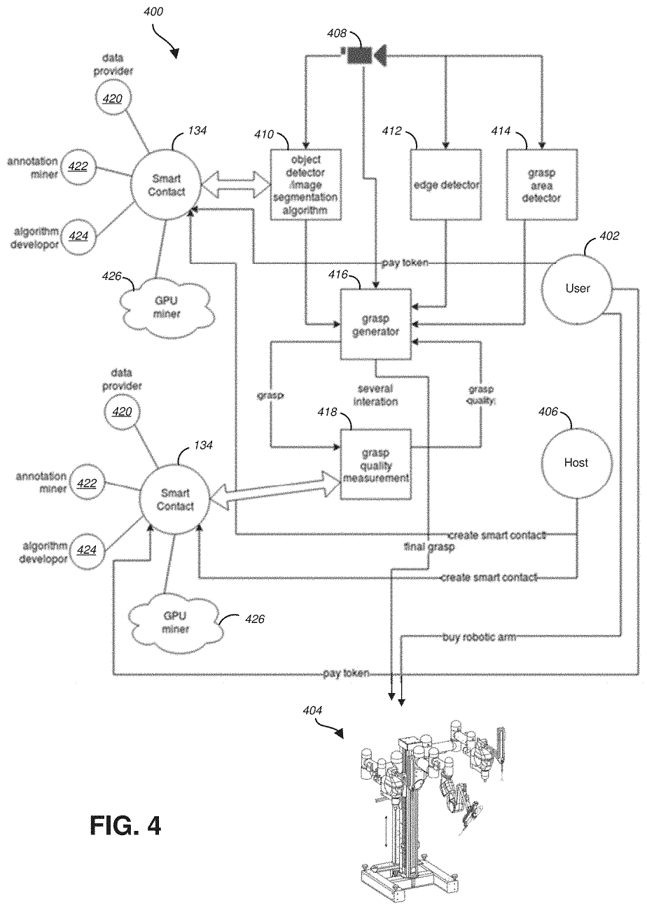

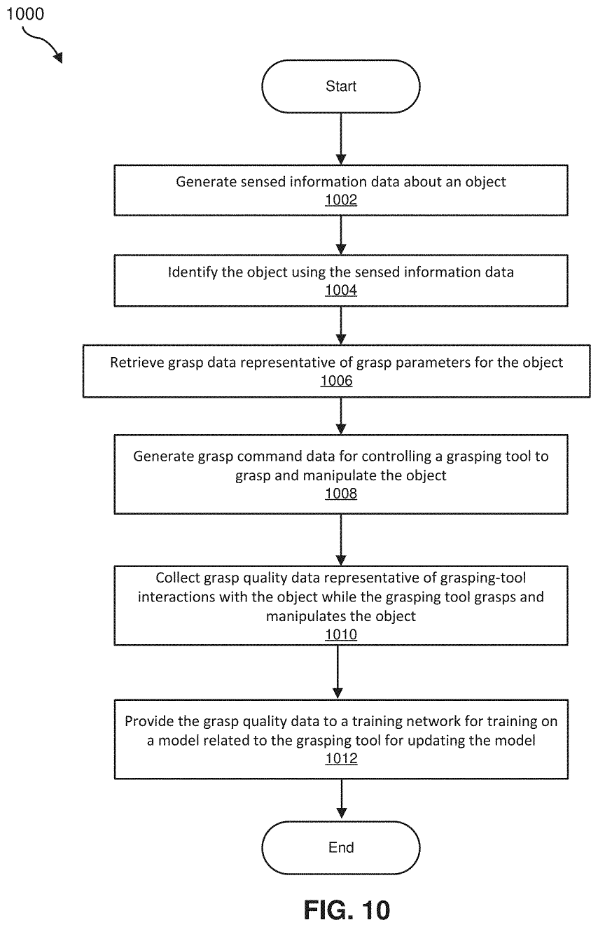

The following will provide, with reference to FIGS. 1-2, detailed descriptions of example systems for artificial-intelligence-based automated object identification and manipulation. Detailed descriptions of corresponding computer-implemented methods will also be provided in connection with FIGS. 3 and 10. Detailed descriptions of exemplary systems will be provided in connection with FIGS. 4-9.

FIG. 1 is a block diagram of an example system 100 artificial-intelligence-based automated object identification and manipulation. As illustrated in FIG. 1, example system 100 may include one or more modules 102 for performing one or more tasks. As will be explained in greater detail below, modules 102 may include a receiving module 104, a creating module 106, an evaluating module 108, a providing module 110, a collecting module 112, an analyzing module 114, and a wallet module 115. Although illustrated as separate elements, one or more of modules 102 in FIG. 1 may represent portions of a single module or application.

In certain embodiments, one or more of modules 102 in FIG. 1 may represent one or more software applications or programs that, when executed by a computing device, may cause the computing device to perform one or more tasks. For example, and as will be described in greater detail below, one or more of modules 102 may represent modules stored and configured to run on one or more computing devices, such as the devices illustrated in FIG. 2 (e.g., computing device 202 and/or server 204). One or more of modules 102 in FIG. 1 may also represent all or portions of one or more special-purpose computers configured to perform one or more tasks.

As illustrated in FIG. 1, example system 100 may also include one or more memory devices, such as memory 116. Memory 116 generally represents any type or form of volatile or non-volatile storage device or medium capable of storing data and/or computer-readable instructions. In one example, memory 116 may store, load, and/or maintain one or more of modules 102. Examples of memory 116 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Example system 100 may also include one or more physical processors, such as physical processor 136. Physical processor 136 generally represents any type or form of hardware-implemented processing unit capable of interpreting and/or executing computer-readable instructions. In one example, physical processor 136 may access and/or modify one or more of modules 102 stored in memory 116. Additionally, or alternatively, physical processor 136 may execute one or more of modules 102 to facilitate artificial-intelligence-based automated object identification and manipulation. Examples of physical processor 136 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Example system 100 may also include one or more data storage devices, such as data storage device 118. Data storage device 118 generally represents any type or form of storage device or medium capable of storing data and/or other computer-readable instructions. For example, data storage device 118 may be a magnetic disk drive (e.g., a so-called hard drive), a solid-state drive, a floppy disk drive, a magnetic tape drive, an optical disk drive, a flash drive, or the like.

In certain embodiments, data storage device 118 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Data storage device 118 may also include other similar structures or devices for allowing computer software, data, or other computer-readable instructions to be loaded into system 100. For example, data storage device 118 may be configured to read and write software, data, or other computer-readable information. Data storage device 118 may also be a part of system 100 or may be a separate device accessed through other interface systems.

In certain embodiments, such as the illustrated example in FIG. 1, data storage device 118 can store data representative of a customer data 120, a developer request 122 including one or more approval conditions 124, a subsystem request 126, a developer proposal 128 including a trained model 130, working environment information 132, a smart contract 134, and a blockchain 140 including a blockchain ledger 142 as described below.

In some embodiments, as discussed in greater detail below, the systems and methods described herein can include peer-to-peer cryptographic blockchain 140, virtual currency, and smart contract management. In some such embodiments, the systems and methods described herein can include peer-to-peer cryptographic virtual currency trading for an exchange of one or more virtual tokens for goods or services. In some such embodiments, compensation can include currency, which can include flat currency, virtual currency, or a combination thereof. Also, in some such embodiments, systems and methods provide smart contract management such that agreements can be created in the form of smart contracts 134.

Embodiments disclosed herein can include systems and methods that include peer-to-peer cryptographic virtual currency trading for an exchange of one or more tokens in a wallet module 115, also referred to as a virtual wallet 115, for purchasing goods (e.g., a trained model or customer training data) or services (e.g., processing power or mining provided by a mining mode). The system can determine whether the virtual wallet 115 has a sufficient quantity of Blockchain tokens to purchase the goods or services at the purchase price. In various embodiments, in response to verifying that the virtual wallet 115 has a sufficient quantity of Blockchain tokens, the purchase is completed. In one or more embodiments, if the virtual wallet 115 has insufficient Blockchain tokens for purchasing goods or services, the purchase is terminated without exchanging Blockchain tokens.

A cryptographic virtual currency is a digital medium of exchange that enables distributed, rapid, cryptographically secure, confirmed transactions for goods and/or services. Cryptographic virtual currencies can include specifications regarding the use of virtual currency that seeks to incorporate principles of cryptography (e.g., public-key cryptography) to implement a distributed and decentralized economy. A virtual currency can be computationally brought into existence by an issuer (e.g., “mined”). Virtual currency can be stored in a virtual cryptographic wallet module 115, which can include software and/or hardware technology to store cryptographic keys and cryptographic virtual currency. Virtual currency can be purchased, sold (e.g., for goods and/or services), traded, or exchanged for a different virtual currency or cryptographic virtual currency, for example. A sender makes a payment (or otherwise transfers ownership) of virtual currency by broadcasting (e.g., in packets or other data structures) a transaction message to nodes 420 on a peer-to-peer network 920. The transaction message can include the quantity of virtual currency changing ownership (e.g., four tokens) and the receiver's (i.e., the new token owner's) public key-based address. Transaction messages can be sent through the Internet, without the need to trust a third party, so settlements can be extremely timely and efficient.

In one or more embodiments, the systems and methods described herein can include a cryptographic protocol for exchanging virtual currency between nodes 420 on a peer-to-peer network 920. A wallet module 115 or transaction can house one or more virtual tokens.

Systems and methods described herein in various embodiments can generate and/or modify a cryptographic virtual currency wallet 115 for facilitating transactions, securely storing virtual tokens, and providing other technology such as generating and maintaining cryptographic keys, generating local and network messages, generating market orders, updating ledgers, performing currency conversion, and providing market data, for example.

The described technology, in various embodiments, can verify virtual currency ownership to prevent fraud. Ownership can be based on ownership entries in ledgers 142 that are maintained by devices connected in a decentralized network, including the network 920 of nodes 420 and the server 204. The ledgers 142 can be mathematically linked to the owners' public-private key pairs generated by the owners' respective wallets, for example. Ledgers 142 record entries for each change of ownership of each virtual token exchanged in the network 920. A ledger 142 is a data structure (e.g., text, structured text, a database record, etc.) that resides on all or a portion of the network 920 of nodes 420. After a transaction (i.e., a message indicating a change of ownership) is broadcast to the network 920, the nodes 420 verify in their respective ledgers 142 that the sender has proper chain of title, based on previously recorded ownership entries for that virtual token. Verification of a transaction is based on mutual consensus among the nodes 420. For example, to verify that the sender has the right to pass ownership to a receiver, the nodes 420 compare their respective ledgers 142 to see if there is a break in the chain of title. A break in the chain of title is detected when there is a discrepancy in one or more of the ledgers 142, signifying a potentially fraudulent transaction. A fraudulent transaction, in various embodiments, is recorded (e.g., in the same ledger 142 or a different ledger 142 and/or database) for use by the authorities, for example (e.g., the Securities and Exchange Commission). If the nodes 408 agree that the sender is the owner of the virtual token, the ledgers 142 are updated to indicate a new ownership transaction, and the receiver becomes the virtual token's owner.

Systems and methods described herein also provide smart contract 134 management. A smart contract 134 is a computerized transaction protocol that executes the terms of an agreement. A smart contract 134 can have one or more of the following fields: object of agreement, first party blockchain address, second party blockchain 140 address, essential content of contract, signature slots and blockchain 140 ID associated with the contract. The contract can be generated based on the user input or automatically in response to predetermined conditions being satisfied. The smart contract 134 can be in the form of bytecodes for machine interpretation or can be the markup language for human consumption. If there are other contracts that are incorporated by reference, the other contracts are formed in a nested hierarchy like program language procedures/subroutines and then embedded inside the contract. A smart contract 134 can be assigned a unique blockchain 140 number and inserted into a blockchain 140. The smart contract 134 can be sent to one or more recipients for executing the terms of the contract and, if specified contractual conditions are met, the smart contract 134 can authorize payment. If a dispute arises, the terms in the smart contract 134 can be presented for a judge, jury, or lawyer to apply legal analysis and determine the parties' obligations.

Advantages of a blockchain 140 smart contract 134 can include one or more of the following:

Speed and real-time updates. Because smart contracts 134 use software code to automate tasks that are typically accomplished through manual means, they can increase the speed of a wide variety of business processes.

Accuracy. Automated transactions are not only faster but less prone to manual error.

Lower execution risk. The decentralized process of execution virtually eliminates the risk of manipulation, nonperformance, or errors, since execution is managed automatically by the network rather than an individual party.

Fewer intermediaries. Smart contracts can reduce or eliminate reliance on third-party intermediaries that provide “trust” services such as escrow between counterparties.

Lower cost. New processes enabled by smart contracts require less human intervention and fewer intermediaries and will therefore reduce costs.

Example system 100 in FIG. 1 may be implemented in a variety of ways. For example, all or a portion of example system 100 may represent portions of example system 200 in FIG. 2. As shown in FIG. 2, system 200 may include a third-party entity computing device 202 in communication with a server 204 via a network 208. The server 204 may also be in communication with a developer computing device 206 via network 208. Network 208 is represented as a network cloud, which could be an enterprise network, the Internet, a private network, etc. In one example, all or a portion of the functionality of modules 102 may be performed by computing device 202, server 204, computing device 206, and/or any other suitable computing system. As will be described in greater detail below, one or more of modules 102 from FIG. 1 may, when executed by at least one processor of computing devices 202, 206, and/or server 204, enable computing devices 202, 206 and/or server 204 to perform artificial-intelligence-based automated object identification and manipulation. For example, and as will be described in greater detail below, one or more of modules 102 may cause server 204 to receive a subsystem request 126 related to a subsystem for an object identification and manipulation system from third-party entity computing device 202; to receive customer data 120 related to an operation of the subsystem, the customer data 120 including at least one of automated object identification and automated object manipulation from third-party entity computing device 202; to create a developer request for a model suitable for use as the requested subsystem, the developer request including at least one approval condition; to evaluate a developer proposal received from the developer computing device 206 in response to the developer request, the developer proposal including a trained model, the evaluating including determining an accuracy level of the trained model, and the evaluating including designating the trained model as an approved model if the developer proposal is approved; and to provide the approved model to the third-party entity computing device 202 in response to the subsystem request 126.

Third-party computing device 202 and developer computing device 206 generally represent any type or form of computing device capable of reading computer-executable instructions. For example, computing devices 202, 206 may include an endpoint device (e.g., a mobile computing device) running client-side software capable of transferring data across a network such as network 208. Additional examples of computing devices 202, 206 include, without limitation, laptops, tablets, desktops, servers, cellular phones, Personal Digital Assistants (PDAs), multimedia players, embedded systems, wearable devices (e.g., smart watches, smart glasses, etc.), smart vehicles, smart packaging (e.g., active or intelligent packaging), gaming consoles, so-called Internet-of-Things devices (e.g., smart appliances, etc.), variations or combinations of one or more of the same, and/or any other suitable computing device.

As illustrated in FIG. 2, example computing devices 202, 206 may also include one or more memory devices, such as memory 116. Memory 116 generally represents any type or form of volatile or non-volatile storage device or medium capable of storing data and/or computer-readable instructions. In one example, memory 116 may store, load, and/or maintain one or more of modules 102. Examples of memory 116 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, and/or any other suitable storage memory.

Example computing devices 202, 206 may also include one or more physical processors, such as physical processor 136. Physical processor 136 generally represents any type or form of hardware-implemented processing unit capable of interpreting and/or executing computer-readable instructions. In one example, physical processor 136 may access and/or modify one or more of modules 102 stored in memory 116. Additionally, or alternatively, physical processor 136 may execute one or more of modules 102 to facilitate artificial-intelligence-based automated object identification and manipulation. Examples of physical processor 136 include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, and/or any other suitable physical processor.

Example computing devices 202, 206 may also include one or more data storage devices, such as data storage device 118. Data storage device 118 generally represents any type or form of storage device or medium capable of storing data and/or other computer-readable instructions. For example, data storage device 118 may be a magnetic disk drive (e.g., a so-called hard drive), a solid-state drive, a floppy disk drive, a magnetic tape drive, an optical disk drive, a flash drive, or the like.

In certain embodiments, data storage device 118 may be configured to read from and/or write to a removable storage unit configured to store computer software, data, or other computer-readable information. Examples of suitable removable storage units include, without limitation, a floppy disk, a magnetic tape, an optical disk, a flash memory device, or the like. Data storage device 118 may also include other similar structures or devices for allowing computer software, data, or other computer-readable instructions to be loaded into computing devices 202, 206. For example, data storage device 118 may be configured to read and write software, data, or other computer-readable information. Data storage device 118 may also be a part of computing device 202, 206 or may be a separate device accessed through other interface systems.

In certain embodiments, such as the illustrated example in FIG. 2, computing device 202 can include a data storage device 118 that can store data representative of customer data 120, a subsystem request 126, and working environment information 132. Computing device 206 can include a data storage device 118 that can store data representative of a developer proposal 128 and a trained model 130.

Server 204 generally represents any type or form of computing device that can facilitate access to remote computing devices, including third-party computing devices 202, 206. Additional examples of server 204 include, without limitation, security servers, application servers, web servers, storage servers, and/or database servers configured to run certain software applications and/or provide various security, web, storage, and/or database services. Although illustrated as a single entity in FIG. 2, server 204 may include and/or represent a plurality of servers that work and/or operate in conjunction with one another.

Network 208 generally represents any medium or architecture capable of facilitating communication or data transfer. In one example, network 208 may facilitate communication between third-party computing devices 202, 206, and server 204. In this example, network 208 may facilitate communication or data transfer using wireless and/or wired connections. Examples of network 208 include, without limitation, an intranet, a Wide Area Network (WAN), a Local Area Network (LAN), a Personal Area Network (PAN), the Internet, Power Line Communications (PLC), a cellular network (e.g., a Global System for Mobile Communications (GSM) network), portions of one or more of the same, variations or combinations of one or more of the same, and/or any other suitable network.

FIG. 3 is a flow diagram of an example computer-implemented method 300 for artificial-intelligence-based automated object identification and manipulation, for example performed by system 200. The steps shown in FIG. 3 may be performed by any suitable computer-executable code and/or computing system. In one example, each of the steps shown in FIG. 3 may represent an algorithm whose structure includes and/or is represented by multiple sub-steps.

In some embodiments, automated object identification and manipulation can include systems and processes associated with AI pattern recognition technology and its application to building, modifying, maintaining, and operating automated robotic grasping apparatus, including computer-based observation and analysis of an object. The object analysis can differ depending on various parameters and constraints, but will generally include acquiring data and processing the data to locate, grasp, and manipulate an object.

In general, an autonomous robotic grasping apparatus can include one or more subsystems that each operate according to respective algorithms for planning and executing an object interaction.

The terms “automated” and “autonomous” as used herein, generally refer to a characteristic of a machine to use perception of environment information 132 to plan, revise, or perform certain operations without human intervention, and contrasts from systems that require human input or manipulation, or systems that operate strictly according to pre-programmed actions. Examples include, without limitation, interpretation of relevant attributes that provide indications of an identity of an object and classifying the object appropriately, or interpretation of relevant conditions to grasp an object appropriately.

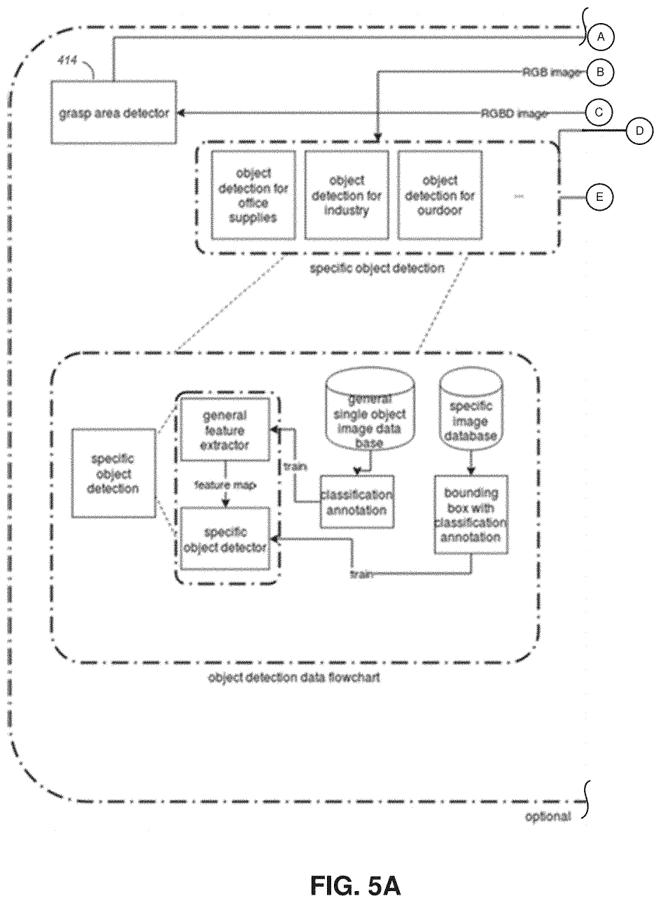

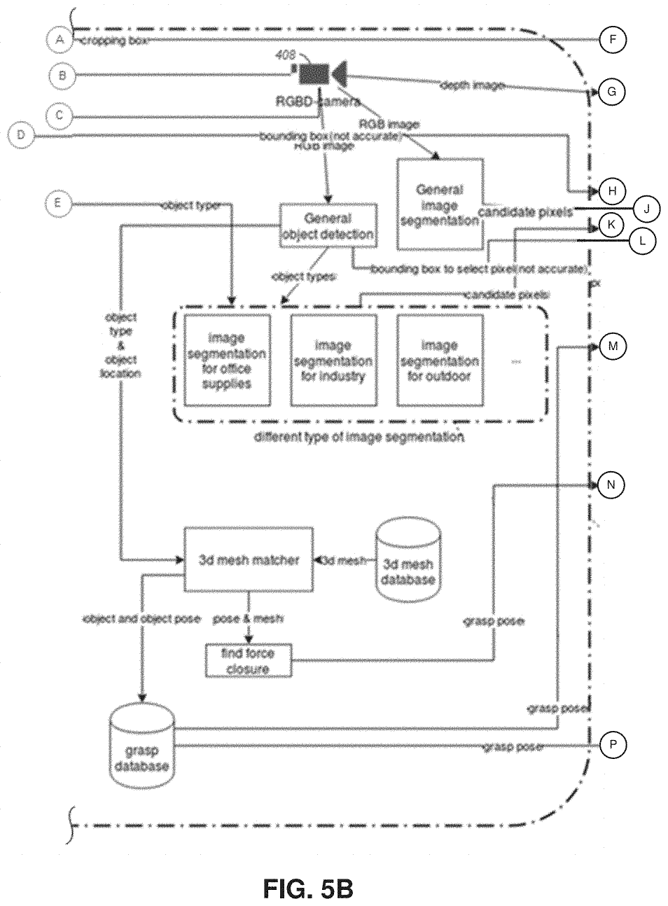

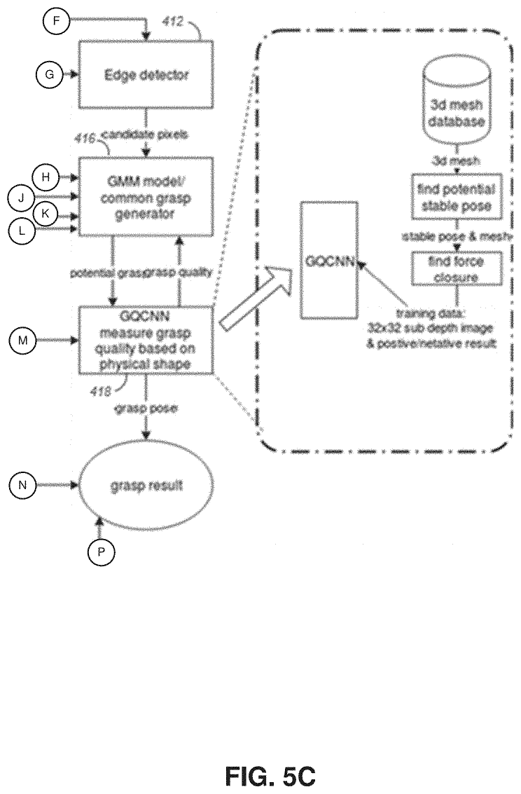

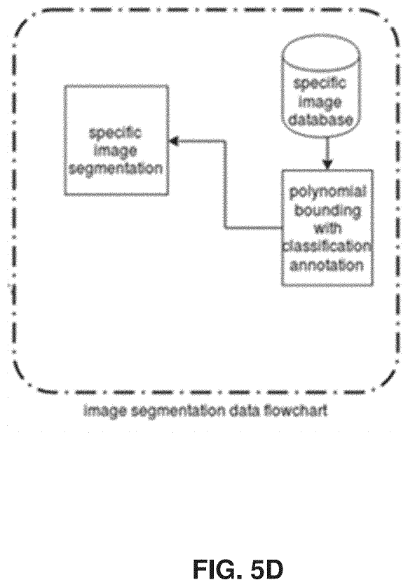

As illustrated in FIG. 3, at step 302, one or more of the systems described herein can receive a subsystem request 126 from a third-party entity. The subsystem request 126 can be a request for a subsystem that is related to control of an object identification and manipulation system, such as an autonomous robotic grasping apparatus. For example, referring to FIGS. 4 and 5A-5D, in some embodiments, a pick and place system 400 is shown that constitutes an example of an artificial-intelligence-based automated object identification and manipulation system having an autonomous robotic grasping apparatus 404. The system 400 has a modular construction that can include one or more cameras 408 and other sensors, and one or more processor-based subsystems 410-418 capable of processing input sensor data about an object for predicting an optimal grasp or manipulation operation for the object. Thus, the subsystem request 126 can include a request for one or more of subsystems 410-418.

The subsystem request 126 can also include customer data 120, such as contact information, price, space, power, and/or time constraints, information related to the customer's existing grasping system or lack thereof, and/or data representative of an operation of the subsystem, such as data representative of at least one physical feature for each of a plurality of different objects and/or data representative of at least one grasping parameter for each of a plurality of different object. For example, the customer data 120 can include data related to automated object identification and/or automated object manipulation, such as training data that can be used for training a model for the requested subsystem. For example, receiving module 104 may, as part of server 204 in FIG. 2, receive customer data 120 and a subsystem request 126 from the third-party entity computing device 202. In some embodiments, the server 204 can store the received customer data 120 and subsystem request 126 in data storage 118. In some embodiments, the server 204 can store the received subsystem request 126 in data storage 118. Additionally, or alternatively, the customer data 120 and the subsystem request 126 can be stored in a distributed blockchain 140 structure.

In some embodiments, step 302 can include collecting working environment information 132 related to the subsystem request 126 from the third-party entity computing device 202. For example, receiving module 104 may, as part of server 204 in FIG. 2, receive working environment information 132 from the computing device 202. In some embodiments, grasping apparatus user 402 and the server 204 host 406 can be more or less involved in the exchange of the environment information 132. In some embodiments, the requested environment information 132 can be provided as part of a system configuration file or the like that is stored on the computing device 202 and can be automatically forwarded by computing device 202 in response to a remote request by the server 204. The working environment information 132 can be received with the subsystem request 126 or can be received in response to a follow-up request from the server 204 for additional information about working conditions of the subsystem to allow for analysis of the working environment information 132 to determine subsystem requirements. Such environment information 132 can be particularly desirable where unusual or unique conditions exist, or where environmental conditions have the potential to interfere with the operation of a standard autonomous robotic grasping apparatus. Some non-limiting examples can include extreme temperatures, low-light conditions, excessive vibrations, unusually high electromagnetic interference, underwater operations, low gravity operations, or other conditions that could interfere with standard machine-learning algorithms or otherwise may be outside the prerequisites for standard machine-learning algorithms.

Specific, non-limiting examples of subsystems can include one or more of an object detection and image segmentation subsystem 410, an edge detector subsystem 412, a grasp area detector subsystem 414, and a grasp quality measurement subsystem 418, which all feed data to a grasp subsystem 416. These subsystems can operate according to respective models that can map sensor data to something about the object, such as an identity of the object, or to something happening with the object, such as slip identification during a grasping operation.

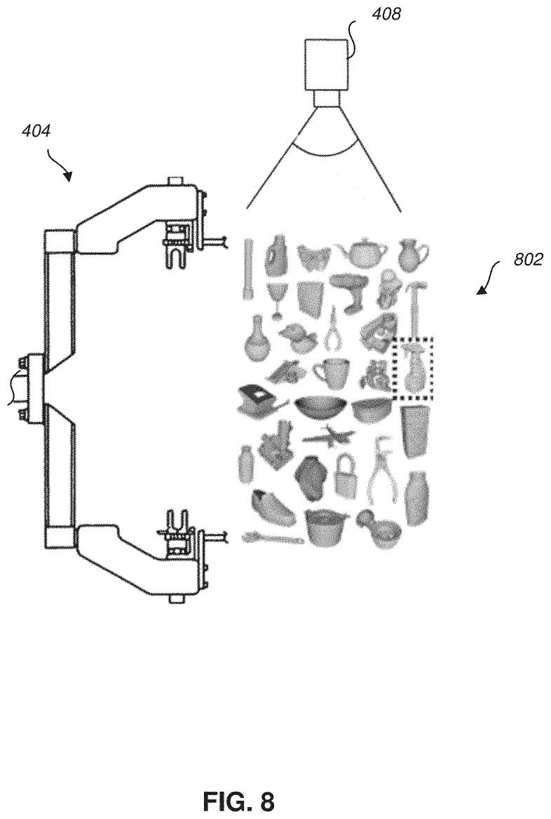

For example, as shown in FIG. 8, one or digital still cameras 408, independently or in concert with other can collect image data sensor data by sensing information about any of a variety of objects 802 to prepare for a grasping operation by a grasping tool 404, such as a robotic-arm type of grasping tool. Sensors 408 can include a camera or other types of imaging sensors, such as object detectors or edge detectors. The sensors 408 can be configured to input data of a 3D image of an object and can include a table supporting the object. The sensor data can be annotated to where the object is with respect to the table, and an outline of the object that can include information such as dimensions of the object and/or location of the object, such as location coordinates in a defined 3-dimensional space. The annotated data can be part of a catalog of such data that can be used for object identification.

Suitable processors include central processing units (CPUs), graphics processing units (GPUs), system-on-chip class field-programmable gate arrays (SoC-class FPGAs), and AI accelerators. The object detection and image segmentation subsystem 410, edge detector subsystem 412, and grasp area detector subsystem 414 all receive image data from one or more cameras 408 and/or other sensors and output information derived from the image data to the grasp generator 416, which also receives the image data. The grasp quality measurement subsystem 418 receives grasp data from the grasp generator 416 during an object interaction and derives information for making changes, if needed, to the grasp.

An object detection and image segmentation subsystem 410 can include separate algorithms for object detection and image segmentation, respectively, or can include a single algorithm that combines the two tasks for locating objects in digital images. In general, an object detection algorithm inputs a digital image and seeks to identify one or more separate objects within the digital image, and outputs classes and locations for all of the objects, which may include one or more different classes in a single image. This is in contrast with image recognition algorithms, which inputs a digital image and outputs one classification for the image from a set of classes). Image segmentation is the process of partitioning a digital image into multiple segments (sets of pixels, also known as super-pixels). More precisely, image segmentation is the process of assigning a label to every pixel in an image such that pixels with the same label share certain characteristics. The result of image segmentation is a set of segments that collectively cover the entire image, where pixels in a segment share some characteristic or computed property, such as color, intensity, or texture. Image segmentation and object recognition can be combined to partition an image into segments and identify segments that represent an object.

An edge detector subsystem 412 can include a model that has been trained to identify edges of objects in digital images. A common example is a Canny edge detector, which is an edge detection operator that uses a multi-stage algorithm to detect a wide range of edges in images. Edge detection can be useful for extract structural information from different vision objects and dramatically reducing the amount of data to be processed. The Canny edge detection algorithm can include five basic stages: (1) Apply a noise-reduction and image smoothing filter at least to areas away from likely edges; (2) Find the intensity gradients of the image; (3) Apply non-maximum suppression to get rid of spurious response to edge detection; (4) Apply double threshold to determine potential edges; and (5) Track edge by hysteresis: Finalize the detection of edges by suppressing all the other edges that are weak and not connected to strong edges.

A grasp area detector subsystem 414 can include a model that has been trained to that map input image data to a best grasping pose of the autonomous robotic grasping apparatus 404. According to some embodiments, for example, an input image is first processed to detect graspable objects and segment them from the remainder of the image data using geometrical features of both the object and the autonomous robotic grasping apparatus 404. Then, a convolutional neural network is applied on these graspable objects, which is a classification algorithm that can be used for finding the best graspable area for each object.

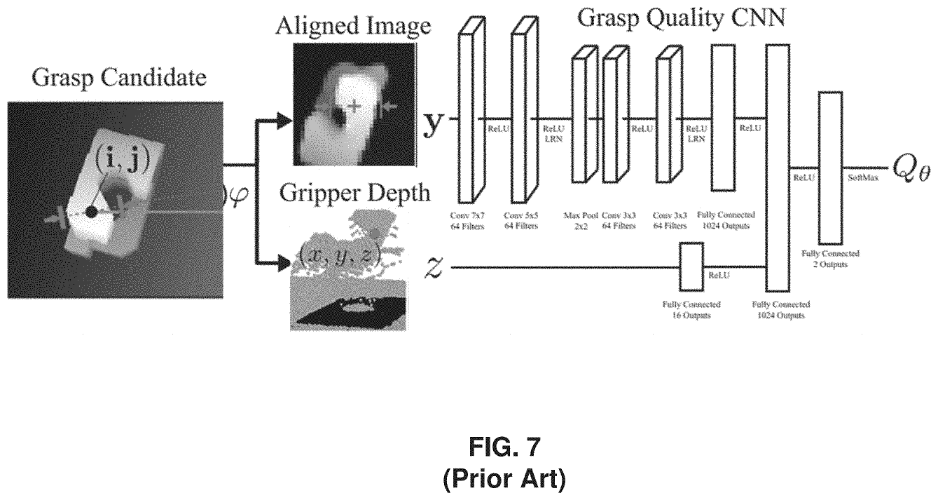

A grasp quality measurement subsystem 418 can include a model that has been trained to predict analytic robustness of candidate grasps from depth images. For example, the model can be trained using synthetic training data from 3-D models, as well as point clouds, grasps, and associated analytical grasp metrics. Referring now also to FIG. 7, in some embodiments, the grasp quality measurement subsystem can include a Grasp Quality- (GQ-)CNN model that processes at least five different attributes: (1) depth images transformed to align the grasp center with the image center and the grasp axis with the middle row of pixels; (2) configuration of the robot gripper corresponding to the grasp; (3) value of the robust epsilon metric computed according to the Dex-Net 2.0 graphical model; (4) value of the epsilon metric, without measuring robustness to perturbations in object pose, gripper pose, and friction; and (5) value of force closure, without measuring robustness to perturbations in object pose, gripper pose, and friction.

FIG. 7 shows an architecture of the Grasp Quality Convolutional Neural Network (GQ-CNN). Planar Grasp Candidates u=(i, j, φ, z) are generated from a depth image and transformed to align the image with the grasp center pixel (i, j) and orientation φ. The architecture contains four convolutional layers in pairs of two separated by ReLU nonlinearities followed by 3 fully connected layers and a separate input layer for the z, the distance of the gripper from the camera. The use of convolutional layers was motivated by the relevance of depth edges as features for learning in previous research [3, 32, 35] and the use of ReLUs was motivated by image classification results [29]. The network estimates the probability of grasp success (robustness) Qθ0 ∈[0, 1], which can be used to rank grasp candidates. (Right) The first layer of convolutional filters learned by the GQ-CNN on Dex-Net 2.0. The filters appear to compute oriented image gradients at various scales, which may be useful for inferring contact normals and collisions between the gripper and object.

The Grasp Quality Convolutional Neural Network (GQ-CNN) architecture defines the set of parameters Θ used to represent the grasp robustness function Qθ. The GQ-CNN takes as input the Gripper Depth from the camera 408 z-axis, and a depth image centered on the grasp center pixel v=(i, j) and aligned with the grasp axis orientation φ. The image-gripper alignment removes the need to learn rotational invariances that can be modeled by known, computationally-efficient image

An evaluation stage process can include (1) presenting an object to the autonomous robotic grasping apparatus 404, (2) receiving a 3-D point cloud that identifies a one or more gasp candidates, (3) process the identified candidate data using the GQ-CNN model to determine the most robust grasp candidate, (4) perform a trial run using the grasp candidate, where the trial run includes lifting, transporting, and shaking the object. The GQ-CNN model ranks potential grasps by a quantity called the grasp robustness. The grasp robustness represents the probability of grasp success predicted by models from mechanics, such as whether or not the grasp can resist arbitrary forces and torques according to probability distributions over properties such as object position and surface friction.

Alternative embodiments can use one of several other known algorithms for the grasp quality subsystem, for example where grasps are planned using (1) a physics-based analytic metrics based on caging, (2) grasp wrench space (GWS) analysis, or (3) robust GWS analysis.

A typical object interaction includes two main stages: grip initiation, and object lifting. During the grip initiation stage, the grasping apparatus closes onto an object until an estimated normal force is above a certain threshold for the identified object. The threshold can be chosen to be very small to avoid damaging the object. Once the grasping apparatus is in contact with the object, the position controller can be stopped, and a grip force controller can then be employed. The force control is used for the entire object-lifting phase to adjust grip force as appropriate when object slip is detected and according to how the slip is classified.

During a grasping operation, sensors can be used for slip detection. Examples of slip detection techniques can include force-derivative methods and pressure-based methods. Force-derivative methods use changes in the estimated tangential force to detect slip. Because the gripper tangential force should become larger as the grasping apparatus is lifting an object off a supporting surface, the negative changes of the tangential force can be used to detect a slip event. Pressure-based methods using pressure sensors. For example, pressure sensors can detect slip-related micro-vibrations rubbing occurs between the grasping apparatus and the object.

When slips are detected, data can also be evaluated for slip classification. Examples of slip classifications include linear slip and rotational slip. During a linear slip, the object maintains its orientation with respect to the grasper but gradually slides out of the grasping apparatus. During rotational slip, the center of mass of the object tends to rotate about an axis normal to the grasping apparatus surface, although the point of contact with the grasping apparatus might stay the same. Discriminating between these two kinds of slip can allow the grasping apparatus to react and control grasp forces accordingly. To be able to classify linear and rotational slip, a neural network is trained to learn the mapping from time-varying sensor values to a class of the slip.

Referring again to FIG. 3, at step 304, one or more of the systems described herein may create a developer request for a model suitable for the requested subsystem, where the developer request includes at least one approval condition. For example, server 204 can generate a developer request 122 that includes at least one approval condition 124. In some embodiments, the developer request 122 can be sent from the server 204 to the developer computing device 206, for example where the developer computing device 206 had previously registered or otherwise requested to receive notifications regarding developer requests. Alternatively, the developer request 122 can be posted on a webpage hosted by the server 204 that is accessible by the developer computing device 206 such that the developer computing device 206 can access the server 204 and download the developer request 122. The approval condition 124 can related to a variety of conditions, such as time frame, performance, and price that the user is willing to pay.

Referring now also to FIGS. 1-9, the disclosed systems and methods can also provide a blockchain 414 based subsystem market for developers and users to trade subsystems such as object detection subsystems 410 and edge detection subsystems 412. The disclosed systems and methods can allow a user 406 to easily assembly a customized object identification and manipulation system based on their own needs. The disclosed systems and methods can provide a blockchain 414 based data market for algorithm developers 424, annotation miners 422, and data providers 420 to trade data and provide data annotation service. The disclosed systems and methods can provide a blockchain 414 based computing resource market for developers to train model and for users to use online computing resources for object identification and manipulation tasks. The disclosed systems and methods can provide a blockchain 414 based encryption function for data trading, allows developers to train model as well as keeping the data provider's data privacy. The disclosed systems and methods can include a variety of roles, including one or more of the following:

User 402: the user for the algorithm, all users need to do is provide requirements and the Host Organization for payment.

Host Organization 406: The Host Organization provides the system framework, which is a group of smart contracts 134 factory functions that produce the agent smart contract 134 for algorithms, data, and computing-power trading. The Host 406 organization also provides a user-friendly interface to assemble the object identification and manipulation system, listing all subsystems for user to customize. For data miners, the Host Organization provides another group of smart contracts and tools for data annotation.

Algorithm developer 424: Algorithm developer develops subsystems for smart object identification and manipulation and get the Host Organization token paid.

Data provider 420: data provider provides data. They can choose to provide encrypted data or unencrypted data. The disclose system provides two levels of encryption. The first level is an asymmetric cryptographic algorithm. The second level is as homomorphic Encryption.

Annotation miner 422: annotation miner annotates data and gets paid by the Host Organization token.

GPU miner 426: through the disclosed system, a GPU miner provides GPU computing power and gets paid by the Host Organization.

The disclosed object identification and manipulation system has modular construction which can combine edge detection algorithms, object detection algorithms, grasp-quality measurement algorithms, and GMM grasp generating subsystems. It also supports further extension of other subsystems such as image segmentation subsystem. For each of the subsystems, a framework is provided that can be implemented.

In some embodiments, when a user decides to build a customized object identification and manipulation system, the disclosed system can provide a web-page interface for the user to construct the object identification and manipulation system. The disclosed system can provide some public open-source algorithms (i.e., models) such as yolo, GQCNN, Faster-RCNN, which can be used to build a basic object identification and manipulation system. If the basic object identification and manipulation system cannot satisfy the user's requirements, the user can complete a form that describes the user's system working environment. The disclosed system can analyze the user's system working environment and provide a detailed requirement for each subsystem. Then the disclosed system will ask user to provide test data and validation data based on the detailed requirements and choose whether to buy the source code for subsystem. The disclosed system will estimate the price for the implementation based on blockchain 414 history records. The user can pre-save at least the estimated price amount from the Host Organization in user's the Host Organization account. The disclosed system will check it and create a group of smart contract Agents through smart contract Agent Factory, which is included in the disclosed system. Then the algorithm developers will be able to see the algorithm task with requirements and validation data through the disclosed developer interface.

Referring again to FIG. 3, at step 306 the method includes evaluating a developer proposal that was received in response to the developer request, including determining an accuracy level of the trained model. A developer can develop an algorithm and provides an intended price to the server 204. If a developer implements an algorithm and submits it through the disclosed system, the disclosed system will test the algorithm on test data and sign the smart contract. At each block recording time, the smart contract will select the developer-submitted subsystem that passes testing and has the lowest price; the smart contract will pay the corresponding developer in virtual currency, flat currency, or credits that can be traded for other goods or services from the server 204; and the smart contract will submit the algorithm to algorithm database. If no developer implements a subsystem or no subsystems pass the test, the price will increase after each block recording time until it reaches an upper limit set by the user.

Referring again to FIG. 3, the approved model is provided to the third-party entity in response to the subsystem request. After the subsystem is selected, if the user chose to buy the source code, the source code will be submitted to the user. Otherwise the disclosed system can manage the source code in repository, and user can use the subsystem remotely by running it on the Host Organization mining machine (and can pay the Host Organization if part of the agreement). If the user did buy the source code and is willing to provide the subsystem to public on the disclosed system, the disclosed system has another smart contract which allows the user to donate the subsystem and get paid by the Host Organization. Then the subsystem will add it to the public algorithm collections. If the whole system only contains public subsystems and user own subsystems, the disclosed system has smart contract groups which allows the user to donate the whole system and get paid by the Host Organization, and then the whole system will be added to the public algorithm collections.

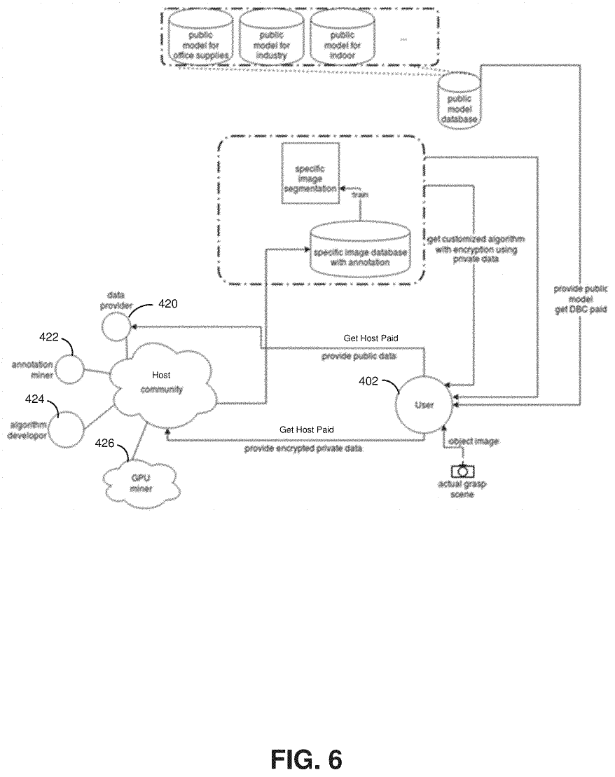

Developers can implement one or more subsystems. For some subsystems, a large amount of training data is desirable, especially for object detection and image segmentation. Referring now also to FIG. 6, for example, for a given class of objects, the data preferable includes the images and the corresponding annotation for the objects. The developers can buy data and get data annotated in the disclosed system. The disclosed system also provides public databases for storing data. After a developer has successfully developed an algorithm with their own data (brought or collected by themselves), the developer has the option of exchanging their data for the Host Organization pay. The disclosed system has a smart contract that allows the user to submit their data in exchange for the Host Organization pay. The submitted data will then be added to the public data collections.

For Data provider, the disclosed system provides an option to sell private data without leaking the data to developer by using homomorphic encryption method. After developers build a deep learning model, they can submit it to the disclosed system to evaluate the possibility of homomorphic encryption. If homomorphic encryption is available on the model and the developer choose to train the model on the disclosed system, then the developer can choose to buy the usage right of private data which is encrypted by homomorphic encryption. The disclosed system will keep the key of the encryption so the private data won't leak to developers.

GPU miners provide GPU and other computing power and get paid by the Host Organization.

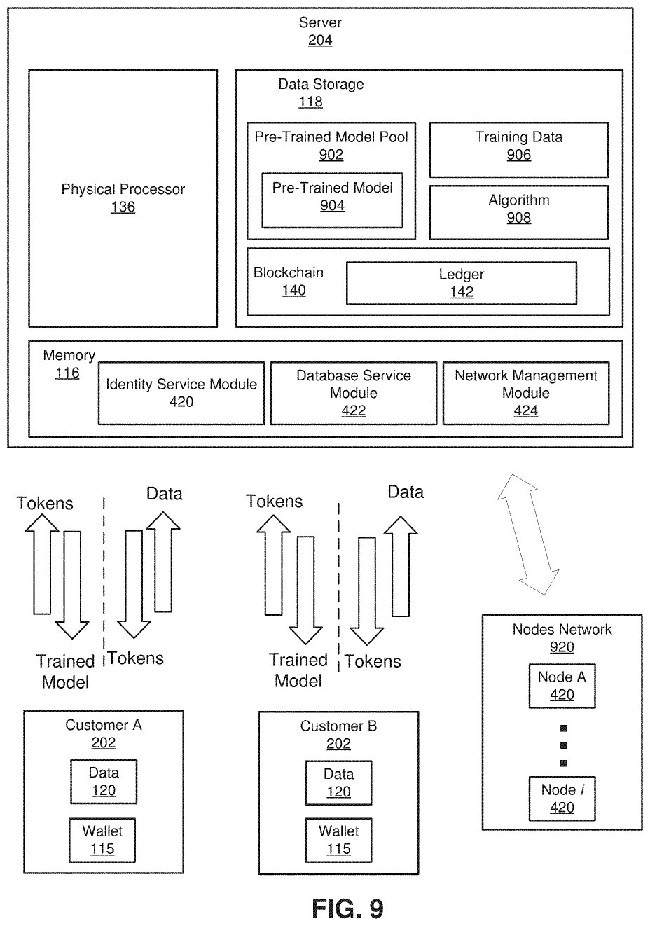

As shown in FIG. 9, customers 202 who hold valuable data 120, or other assets such as trained models can make requests towards the server 204 for a pre-trained model 904 to effectively and efficiently train their own model. The pre-trained model 904 allows users to successfully and effectively train their own model with transfer learning technology, which means they can get the desired model with much less time and computing resources.

Customers 202 can also request a trained model from the server 204. As shown in FIG. 9, a customer 202 can submit a payment of tokens or virtual currency or other form of trade or payment in exchange for a trained model for one of their subsystems. In some embodiments, the server 204 can post the request for handling by another party, such as a developer 424 or a GPU miner 426. The server 204 can maintain a pre-trained model pool 902 that includes partially trained models. In response to the model request from the customer system 202, the server 204 can retrieve a pre-trained model 904 from a pre-trained model pool 902. A pre-trained model 904 is a model that has undergone some training, e.g., has been fed some training data or has undergone some other form of parameter adjustment to improve the accuracy of the model without yet achieving a level of accuracy desired. As a result, a pre-trained model 904 can be ready for deployment in less time, using less computing resources, and using less training data than a model being trained from scratch. Embodiments of the systems and methods disclosed herein can include pre-trained models 904 that can be applied to multiple different industries and research scenes, and the whole system can be updated to be more accurate with the data from different scenes.

In some embodiments, the levels of training data 906 and computing resources can automatically reach predetermined designated threshold levels that trigger construction of such pre-trained models 904. Upon reaching the threshold, a pre-trained model is constructed and then added to the pre-trained model pool 902. The pre-trained model pool 902 includes pre-trained models 904 that can be further trained upon request for a trained model 130 with the help of transfer learning technology. The pre-trained models 904 can be built in a manner similar to a fully trained model, without as much training.

One or more of the systems described herein may generate the trained model 130 from the pre-trained model 904 and the customer data 120. In some embodiments, the received customer data 120 and the pre-trained model 904 are transmitted to one or more of a plurality of networked nodes 420, where the training of the pre-trained model 904 is completed by one or more of the nodes 420. Once the training is complete, the trained model 130 is received from the one or more of the plurality of networked nodes 420. In some embodiments, nodes 420 can provide processing power in exchange for compensation. In such embodiments, the compensation is transmitted to the one or more nodes 420 that provided the processing power to train the model 130.

One or more of the systems described herein may provide the trained model 130 upon completion to the customer 202. In some embodiments, the transmitting of the model 130 may be contingent upon first receiving compensation from the customer 202 for the preparation of the targeted model.

Systems and methods disclosed herein are applicable to many industries, including those where it is desirable to seek out and implement opportunities for increasing production-line automation. Many deep-learning based industrial-level projects confront big challenges that are not flexible enough to be published and shared. Moreover, a centralized deep-learning model is unable to collect idle resources to implement larger-scale computing and time-saving tasks. To address these problems, embodiments of the present disclosure include Blockchain-Based automated object identification and manipulation using AI. Systems and methods herein involve improvements to the performance of AI technologies, allowing for an increased number of industrial issues to be handled by AI technology. Embodiments of the systems and methods disclosed herein can provide improved training accuracy by incorporating the ability to update models in real time as data is received from a multitude of users on an ongoing basis.

After finishing their own model training, the customers 202 can upload their data 120, which may or may not include their trained model, to the server 204. Incoming data and models will be combined into the training data 906 and the pre-trained model pool 902. As the amount of training data 906 grows, pre-trained models 904 in the pre-trained model pool 902 will become more powerful and more accurate. Embodiments of the systems and methods disclosed herein can provide improved training accuracy by incorporating the ability to update models in real time as data is received from a multitude of users on an ongoing basis.

Embodiments of the systems and methods disclosed herein can also allow customers 202 to participate in the blockchain 140 as nodes 420 of nodes network 920. On the server 204, customers can deploy their AI tasks and upload their models and data 220, both of which can be monitored and controlled by contributors based on blockchain technology.

The memory 140 can include modules described herein. In addition, the memory 140 can include a blockchain 414 including a blockchain ledger 412, an identity service module 420, a database service module 422, and a network management module 426. Identity service module 420 can provide authentication, service rules, and service tokens to other server modules and manage commands, projects, customers/users, groups, and roles. Network management module 426 can provide network virtualization technology and network connectivity services to other server services, providing interfaces to service users that can define networks, subnets, virtual IP addresses, and load-balancing. Database service module 422 can provide extensible and reliable relational and non-relational database service engines to users.

As further shown, a plurality of customers 202 are configured to conduct transactions with the server 406 as described in detail below. Also, a plurality of nodes 408 are configured and arranged in a peer-to-peer network 402. Although only two nodes 408 are shown, it should be appreciated that the system can include a plurality of nodes 408, and although only one node network 402 is shown, it should be appreciated that the system can include a plurality of node networks 402. The server 406 can be considered to form part of a distributed storage system with the network 402 of nodes 408.

Thus, according to one exemplary aspect, a plurality of customers 202 can be communicatively coupled to the server 406 through one or more computer networks 206. In some embodiments, the network 106 shown comprises the Internet. In other embodiments, other networks, such as an intranet, WAN, or LAN may be used. Moreover, some aspects of the present disclosure may operate within a single computer, server, or other processor-based electronic device. The server 406 can be connected to some customers 202 that constitute model-requesting customers 202 that are transmitting requests to the server 406, for example for data, models, or model-training service. The server 406 can also be connected to some customers 202 that constitute data-provider customers 202 that are transmitting offers to the server 406 offering training data or trained models. It should be appreciated that a single customer 202 can act as a requesting customer at times and as an offering customer at times, and both an offering and a requesting customer at the same time, for example offering training data in exchange for getting a model trained by the server 406.

The network 402 includes a series of network nodes 408, which may be many different types of computing devices operating on the network 402 and communicating over the network 402. The network 402 may be an autonomous peer-to-peer network, which allows communication between nodes 408 on the network 402, an amount of data access to servers, etc. The number of network nodes 408 can vary depending on the size of the network 402.

A blockchain 414 having a ledger 412 can be used to store the transactions being conducted and processed by the network 402. In some embodiments, blockchain 414 is stored in a decentralized manner on a plurality of nodes 408, e.g., computing devices located in one or more networks 402, and on server 406. Server 406 and Nodes 408 may each electronically store at least a portion of a ledger 412 of blockchain 414. Ledger 412 includes any data blocks 102 that have been validated and added to the blockchain 414. In some embodiments, the server 406 and every node 408 can store the entire ledger 412. In some embodiments, the server 406 and each node 408 can store at least a portion of ledger 412. In some embodiments, some or all of blockchain 414 can be stored in a centralized manner. The server 406 and nodes 408 can communicate with one another via communication pathways that can include wired and wireless connections, over the internet, etc. to transmit and receive data related to ledger 412. For example, as new data blocks are added to ledger 412, the server 406 and nodes 408 can communicate or share the new data blocks with other nodes 408. In some embodiments, the server 406 may not have a ledger 412 of the blockchain 414 stored locally and instead can be configured to communicate blockchain interaction requests to one or more nodes 408 to perform operations on the blockchain 414 and report back to the server as appropriate.

The network 402 of nodes 408 can also serve as a computing-power resource pool for the server 406. In some embodiments, the network 402 can include several networks 402 spread over geographic regions as small as a single node or physical location, or as large as a global collection of networks 402 of nodes 408 dispersed worldwide. Very large global networks 402 of nodes also have the potential to collect and store large amounts of training data.

FIG. 10 is a flow diagram of an example computer-implemented method 1000 for artificial intelligence based automated object identification and manipulation. The steps shown in FIG. 10 may be performed by any suitable computer-executable code and/or computing system. In one example, each of the steps shown in FIG. 10 may represent an algorithm whose structure includes and/or is represented by multiple sub-steps.

As illustrated in FIG. 10, at step 1002 sensed information data is generated about an object. The sensed information data can include image data, location data, and/or orientation data collected using one or more sensors. At step 1004, the object is identified using the sensed information data. The identifying of the object can include recognizing the object as being one of a plurality of different candidate items. At step 1006, grasp data is retrieved that is representative of grasp parameters for the object. The grasp parameters can include information related to grasping surfaces of the object and grasping force limits for the object. At step 1008, grasp command data is generated for controlling a grasping tool to grasp and manipulate the object. The grasp command data can be generated based at least in part on the grasp data. At step 1010, grasp quality data is collected that is representative of grasping-tool interactions with the object while the grasping tool grasps and manipulates the object. The grasp quality data can include sensor data collected by at least one sensor while monitoring grasping-tool as the grasping tool grasps and manipulates the object. At step 1012, the grasp quality data can be provided to a training network for training on a model related to the grasping tool for updating the model.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method for artificial-intelligence-based automated object identification and manipulation, at least a portion of the method being performed by a computing device comprising at least one processor, the method comprising:
receiving, by the one or more computing devices, from a third-party entity:
a subsystem request related to a subsystem for an object identification and manipulation system; and
creating, by the one or more computing devices, a developer request for a model suitable for the subsystem, the developer request including at least one approval condition;
evaluating, by the one or more computing devices, a developer proposal received in response to the developer request, wherein the developer proposal includes a trained model, wherein the evaluating includes determining an accuracy level of the trained model, and wherein the evaluating includes designating the trained model as an approved model if the developer proposal is approved; and
providing, by the one or more computing devices, the approved model to the third-party entity in response to the subsystem request.

2. The computer-implemented method of claim 1, further comprising collecting working environment information related to the subsystem request from the third-party entity.

3. The computer-implemented method of claim 2, further comprising analyzing the working environment information to determine subsystem requirements.

4. The computer-implemented method of claim 1, wherein the receiving, by the one or more computing devices, from the third-party entity, includes receiving customer data related to an operation of the subsystem, the customer data including at least one of automated object identification and automated object manipulation.

5. The computer-implemented method of claim 4, wherein the customer data includes data representative of at least one physical feature for each of a plurality of different objects.

6. The computer-implemented method of claim 4, wherein the customer data includes data representative of at least one grasping parameter for each of a plurality of different objects.

7. The computer-implemented method of claim 1, wherein the condition relates to price, and wherein the price increases after a predetermined period of time if no satisfactory model has yet been received.

8. The computer-implemented method of claim 1, wherein the developer request includes a smart contract that is stored in a blockchain structure and is automatically signed upon approval of a developer proposal.

9. A system for artificial-intelligence-based automated object identification and manipulation, the system comprising:
a receiving module, stored in memory, that receives, from a third-party entity:
a subsystem request related to a subsystem for an object identification and manipulation system; and
a creating module, stored in memory, that creates a developer request for a model suitable for the subsystem, the developer request including at least one approval condition;
an evaluating module, stored in memory, that evaluates a developer proposal received in response to the developer request, wherein the developer proposal includes a trained model, wherein the evaluating includes determining an accuracy level of the trained model, and wherein the evaluating includes designating the trained model as an approved model if the developer proposal is approved;
a providing module, stored in memory, that provides the approved model to the third-party entity in response to the subsystem request; and
at least one physical processor that executes the receiving module, the creating module, the evaluating module, and the providing module.

10. The system can further comprise a collecting module, stored in memory, that collects working environment information related to the subsystem request from the third-party entity.

11. The system can further comprise an analyzing module, stored in memory, that analyzes the working environment information to determine subsystem requirements.

12. The system of claim 9, wherein the receiving module, stored in memory, that receives from the third-party entity, includes customer data related to an operation of the subsystem, the customer data including at least one of automated object identification and automated object manipulation.

13. The system of claim 12, wherein the customer data includes data representative of at least one physical feature for each of a plurality of different objects.

14. The system of claim 12, wherein the customer data includes data representative of at least one grasping parameter for each of a plurality of different objects.

15. The system of claim 9, wherein the condition relates to price, and wherein the price increases after a predetermined period of time if no satisfactory model has yet been received.

16. The system of claim 9, wherein the developer request includes a smart contract that is stored in a blockchain structure and is automatically signed upon approval of a developer proposal.

17. A computer-implemented method for artificial-intelligence-based automated object identification and manipulation, at least a portion of the method being performed by a computing device comprising at least one processor, the method comprising:
generating, by the one or more computing devices, sensed information data about an object collected using one or more sensors;
identifying, by the one or more computing devices, the object using the sensed information data, including recognizing the object as being one of a plurality of different candidate items;
retrieving, by the one or more computing devices, grasp data representative of grasp parameters for the object;
generating, by the one or more computing devices, grasp command data for controlling a grasping tool to grasp and manipulate the object, the grasp command data being generated based at least in part on the grasp data;
collecting, by the one or more computing devices, grasp quality data representative of grasping-tool interactions with the object while the grasping tool grasps and manipulates the object; and
providing, by the one or more computing devices, the grasp quality data to a training network for training a model related to the grasping tool.

18. The computer-implemented method of claim 17, wherein the sensed information data includes at least one of image data, location data, and orientation data.

19. The computer-implemented method of claim 17, wherein the grasp quality data includes sensor data collected by at least one sensor while monitoring grasping-tool as the grasping tool grasps and manipulates the object.

20. The computer-implemented method of claim 17, wherein the grasp parameters include information related to grasping surfaces of the object.

21. The computer-implemented method of claim 17, wherein the grasp parameters include information related to grasping force limits for the object.

22. The computer-implemented method of claim 17, further comprising receiving compensation in exchange for the grasp quality data, wherein compensation includes at least one of a flat currency and a virtual currency.
